(19) United States
(12) Patent Application Publication
(10) Pub. No.: US 2025/0205595 A1
(43) Pub. Date: Jun. 26, 2025

(54) Posture Correction Device

(71) Applicant: Sony Interactive Entertainment Europe Limited, London (GB)

(72) Inventor: Jun Yen Leung, London (GB)

(73) Assignee: Sony Interactive Entertainment Europe Limited, London (GB)

(21) Appl. No.: 18/985,536

(22) Filed: Dec. 18, 2024

(30) Foreign Application Priority Data
Dec. 20, 2023 (GB) GB2319595.1

(51) Int. Cl. A63F 13/28; A63F 13/428

(52) U.S. Cl. CPC A63F 13/285

(57) ABSTRACT

Disclosed herein is a peripheral device of a video game device, configured in use to correct a user's posture, the peripheral device comprising a processor configured to: obtain first orientation information from a gyroscope of the peripheral device; determine an imbalance in the user's posture based on the first orientation information; and adjust the weight distribution of the peripheral device to indicate the user to adjust their posture. Also provided is a method and a computer readable storage medium.

### CROSS-REFERENCE TO RELATED APPLICATION

The present application claims priority from United Kingdom Patent Application No. GB2319595.1 filed Dec. 20, 2023, the disclosure of which is hereby incorporated herein by reference.

### FIELD OF THE INVENTION

The present invention relates to a peripheral device of a video game device configured to indicate a posture adjustment to a user by adjusting a weight distribution of the peripheral device. The indicated posture adjustment corrects an error in the user's posture. A corresponding method is also provided.

### BACKGROUND

A user of a video game device, such as a video game console, interacts with the video game device using a peripheral device, such as a controller, or a headset. Users may use such peripherals for extended periods of time, and may develop a tendency to hold the peripheral at an angle which results in loss of input accuracy.

For example, a user may hold a controller with their left hand being higher than their right hand, or with their wrists being radially deviated. This can lead to injury if maintained for extended periods of time.

Similarly, while using a headset, for example a virtual reality headset, a user may develop the tendency to lean forward by overextending their neck. This too, can lead to injury if maintained for extended periods.

It is therefore important for a user's posture to be corrected while they are using the video game device. Possible approaches require the user to wear a back brace, or flash a message on screen instructing the user to return to a neutral posture. However, the use of a back brace is invasive and uncomfortable. Messages appearing on the screen are immersion breaking and detract from the user experience.

Therefore, there exists a need to provide a suitable way for correcting a user's posture while they use a video game device that is not immersion breaking or invasive.

### SUMMARY OF INVENTION

This need is addressed by aspects of the present invention. According to the present invention, orientation information of a peripheral device is used to determine if the user has an imbalanced posture. A weight distribution of the peripheral is accordingly adjusted in such a way as to indicate to the user how to correct their posture.

According to an aspect of the invention, a peripheral device of a video game device is provided. The peripheral device is configured in use to correct a user's posture, the peripheral device comprising a processor configured to: obtain first orientation information from a gyroscope of the peripheral device; determine an imbalance in the user's posture based on the first orientation information; and adjust the weight distribution of the peripheral device to indicate the user to adjust their posture.

In this way, the user is provided with haptic feedback providing an indication from the peripheral device, in the form of feeling the weight of the controller shift, according to which they intuitively understand that there is a need to adjust the orientation of the peripheral device, resulting in them also correcting imbalanced posture when it occurs. This places less of a burden on the user than invasive back brace devices, and also maintains the user's immersion in the game they are currently playing, because their vision has not been disrupted.

Further, the indication provided by the disclosure provides the user with a subtle encouragement to adjust their posture. That is, the indication is provided by adjusting the weight distribution does not exert a force on the user's body to the extent that their posture is involuntarily corrected. Rather, the adjustment of the weight distribution indicates the user to adjust their posture of their own volition. The user therefore maintains their bodily autonomy, and does not feel as they are not in control of their actions.

Preferably determining an imbalance in the user's posture based on the first orientation information comprises determining when the obtained orientation information from the gyroscope is indicative of a user posture that could be improved, i.e. a sub-optimal posture, for example that may affect the accuracy of user inputs into the peripheral device.

Preferably determining an imbalance in the user's posture based on the first orientation information comprises determining when the first orientation information meets a defined condition (which may be referred to as an “adverse or sub-optimal posture condition”). The defined condition may be met when the first orientation information falls within a predetermined range. Additionally or alternatively the defined condition may be met when a measured variation in the first orientation information displays a predetermined behaviour.

In some examples, adjusting the weight distribution of the peripheral device to indicate the user to adjust their posture may comprises indicating a posture adjustment to the user; wherein the posture adjustment corrects the imbalance in the user's posture.

By indicating a posture adjustment to the user, we intend to mean that the user is provided with a specific indication of how to adjust the controller. In this way, the user is given an intuitive indication of how to adjust their posture based on how the weight distribution of the peripheral device is adjusted. The user naturally reorients the controller according to the weight distribution, which in turn causes them to correct any imbalance in their posture.

To be clear, when we refer to posture, we intend to refer to two distinct types of posture.

The first type of posture is gaming posture, which refers to how the user holds or interacts with peripheral devices of a video game device. A user's gaming posture tends to have an impact on gaming performance. For example, consider a controller with a right handle and a left handle. If the controller is held with the left handle higher than the right handle, this will cause a loss of input accuracy. Further, when the left handle is held higher than the right handle, this indicates an imbalance in the user's posture. For example, the left shoulder may be tensed and higher than the right shoulder. In this situation, the peripheral device described above would adjust the weight distribution of the controller to make the left handle physically heavier, or cause the user to perceive that the left handle is heavier. This encourages the user to lower the left handle, and in turn, lower and release the tension in their left shoulder. The user's gaming posture is therefore improved.

The second type of posture we intend to mean is the user's general posture, which refers to how the user will typically sit or stand, even when not using a video game device or a peripheral device. The peripheral device described above encourages the user to move their muscles, for example their shoulders, to counter posture imbalance. This helps the user to keep their posture in mind, even when they are not using the peripheral device, and can contribute to retraining a user's posture to correct imbalances.

In some examples the processor may further be configured to detect an imbalance based on the orientation information by: determining that the first orientation information indicates that the peripheral device is rotated about an axis of the peripheral device.

When referring to a rotation about an axis, we intend to mean that the peripheral device has been rotated with respect to an initial position, for example a “neutral posture position” or an “optimal posture position”. The initial position may be determined based on preset orientation values, or may be determined when the peripheral device is initialised. Other modes of determining the initial position are of course possible and would be considered by a skilled person depending on the application scenario.

The axis of the peripheral device may comprises a longitudinal axis and/or a transverse axis of the peripheral device.

The longitudinal axis may be understood as an axis extended along a length of the peripheral device. The transverse axis may be understood as an axis at a right angle to the longitudinal axis.

In this way, imbalances or errors in the user's posture can be determined based on tilting away from the longitudinal axis and/or transverse axis of the peripheral device. The corresponding shift in the weight distribution of the controller is such that the user is indicated to tilt the peripheral device back towards the longitudinal or transverse axes of the peripheral device.

In some advantageous examples, the processor may further be configured to: receive second orientation information from the gyroscope of the peripheral device; determine a difference between the first orientation information and the second orientation information; determine a change in the user's posture based on the difference between the first orientation information and the second orientation information; and readjust the weight distribution of the peripheral device responsive to the change in the user's posture.

Accordingly, examples of the present disclosure provide the user with dynamic feedback according to how the user adjusts or corrects their posture in response to the initial weight distribution adjustment. This provides greater accuracy in the posture correction, for example by accounting for the possibility that the user may not completely correct their posture in response to the indication provided by the adjustment of the controller's weight distribution.

In some examples, the peripheral device may comprise a moveable weight connected to the peripheral device, and adjusting the weight distribution of the peripheral device to indicate the user to adjust their posture comprises: adjusting a position of the weight to shift a center of mass of the peripheral device.

In certain examples, the center of mass of the peripheral device may be shifted to indicate the user to reorient the device by tilting the peripheral device toward the axis (i.e., the longitudinal and/or transverse axes) of the peripheral device.

Accordingly, the weight distribution of the controller is physically adjusted. By physically adjusted, we intend to mean that the center of mass of the controller moves in a way that the user can perceive. This is a reliable way of providing a noticeable and clear indication to the user that a posture adjustment should be made, which the user can then act on.

Moreover, the processor may be further configured to adjust the user's perception of the weight distribution of the peripheral device.

By adjusting the user's perception of the weight distribution of the peripheral device, we intend to mean that the weight distribution of the peripheral device is perceived to change, but without physically changing the weight distribution or center or mass of the peripheral device.

For example, the peripheral device may further comprise a spinnable motor, and the processor is configured to adjust the user's perception of the weight distribution by spinning the spinnable motor.

When referring to a spinnable motor, we intend to mean a motor with a spinning element which, when spun, generates lift which in turn exerts a force on the peripheral device.

In this way, the peripheral device is made more compact while still facilitating adjustment of the weight distribution by adjusting the user's perception of the weight distribution of the peripheral device.

The physical and perceptual adjustment to the weight distribution discussed above may be combined to produce a particularly strong change in the weight distribution of the peripheral device. This would be especially useful where a significant posture adjustment is to be indicated to the user.

In some examples, the peripheral device comprises a video game controller.

Alternatively, the peripheral device may comprise a virtual reality headset.

Other specific peripheral devices could of course be configured to perform the above method. However, a video game controller and a virtual reality headset are particularly advantageous as their orientation can consistently predict if the user has an imbalance in their posture.

In some further examples, the orientation sensor may be a gyroscope.

A further aspect of the invention provides a video game system comprising a peripheral device according to any one of the above examples.

Yet another aspect of the invention provides a method for correcting a user's posture comprising: obtaining first orientation information from a gyroscope of a peripheral device; determining an imbalance in the user's posture based on the first orientation information; and adjusting the weight distribution of the peripheral device to indicate the user to adjust their posture.

The method may be further adapted in line with the examples provided in relation to the peripheral device discussed above.

Advantages of the method correspond to advantages of the peripheral device discussed above and are not repeated.

A further aspect of the invention provides a computer readable storage medium comprising instructions, which when executed by a processor of a peripheral device of a video game device, cause the processor to perform a method according to the above aspect.

### BRIEF DESCRIPTION OF DRAWINGS

The invention will be described with reference to the Figures, in which:

FIG. 1 shows a schematic of a video game controller;

FIG. 2A shows a view of the video game controller being tilted away from a longitudinal axis of the controller;

FIG. 2B shows a view of the video game controller having been returned to the longitudinal axis after adjusting the weight distribution of the controller;

FIGS. 3A and 3B show a view of the video game controller being tilted away from a transverse axis of the controller;

FIG. 3C shows a view of the video game controller having been returned to the transverse axis after adjusting the weight distribution of the controller;

FIG. 4 shows a schematic of the video game controller including weight distribution adjustment modules;

FIG. 5 shows a schematic of a virtual reality headset; and

FIG. 6 shows a method for correcting a user's posture.

### DETAILED DESCRIPTION

A user's posture while using a video game device is an important part of the user's overall gaming experience, since a user's posture can affect their input accuracy, and therefore their performance in a video game. Further, it is known that having good posture contributes to overall good health by reducing the likelihood of injuries occurring, for example due to joint misalignment or muscle tension.

It is known that a user interacts with a video game system by providing inputs using a peripheral device, such as a controller or a virtual reality headset. Modern peripheral devices are also capable of providing outputs to the user, such as vibration that corresponds to events occurring in a video game. The disclosure provides a peripheral device with posture correction capabilities. Specifically, the need for the user to correct their posture is indicated by a weight adjustment of the peripheral device.

The peripheral device could be any kind of peripheral device, such as a controller, a headset or a virtual reality headset.

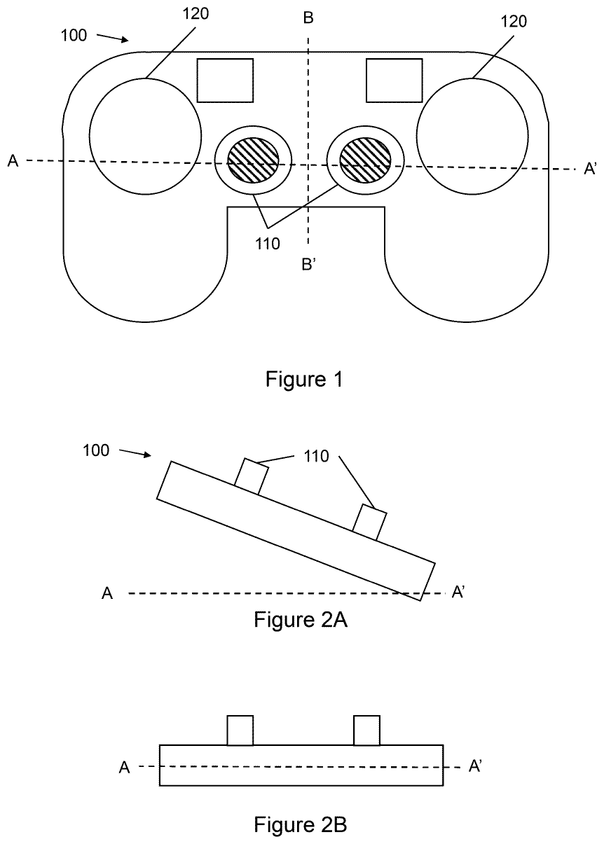

FIG. 1 shows an example controller 100. Below we discuss how the controller 100 is configured to correct imbalances in a user's posture. However, it would be understood by a skilled person that the teachings provided in relation to the controller 100 may be applied to other types of peripheral devices.

Controller 100 comprises joysticks 110, input interfaces 120 a processor 130 and an orientation sensor 140, such as a gyroscope. Also shown in FIG. 1 are longitudinal and transverse axes of the controller 100. The longitudinal axis is marked by line A-A′, and the transverse axis is marked by line B-B′. It would be understood that the controller 100 can include numerous other sensors such as a microphone, an optical sensor, and an accelerometer, as well as other components such as a battery, a charging port, a speaker, a light emitting device and a touch sensitive surface. The controller 20 may also comprise a wireless transceiver for transmitting signals to and receiving signals from a video game system.

It would be understood that references to the longitudinal axis A-A′ and the transverse axis B′B′, also encompass axes parallel to the axes shown in the Figures.

When using the controller, the user may find that their posture changes. For example, the user could find that one shoulder raises higher than the other, which in turn will cause the controller 100 to be tilted, as is shown in FIG. 2A. In FIG. 2A, the controller 100 is tilted away from the longitudinal axis A-A′. In other words, the controller is rotated with respect to the longitudinal axis. Such a tilt or rotation would be caused for example, if the user's right shoulder is higher than the left shoulder, or the left shoulder is higher than the right shoulder. This is an example of an imbalanced posture. If the user persists in this position, then they are at risk of a tension related injury. Further, the imbalance in their posture results in decreased performance in-game, for example due to loss of input accuracy.

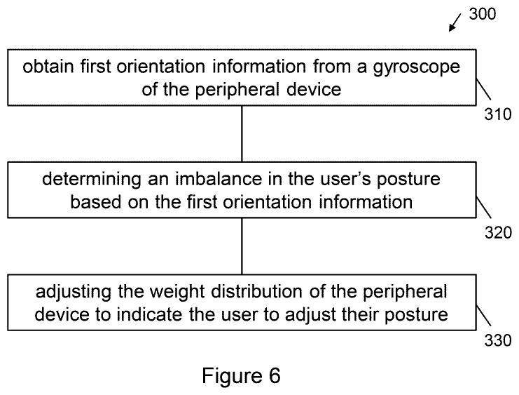

Accordingly, to correct the imbalance in the user's posture, the processor 130 of the controller 100 is configured to perform a method, as set out in FIG. 6.

As shown in FIG. 6, the processor 130 of the controller 100 is configured, at step 310, to obtain first orientation information from an orientation sensor, for example, a gyroscope or other inertial measurement unit of the peripheral device.

The orientation information may be expressed a 1×3 vector containing pitch, yaw, and roll. That is, the orientation information may be expressed in terms of pitch, yaw and roll. Other expressions of orientation or coordinate systems would be used, if a called for by a specific application.

Then, at step 320, the processor 130 is configured to determine an imbalance in the user's posture based on the first orientation information. For example, the processor may determine that the user's posture is imbalanced if the orientation of the controller 100 is outside an acceptable limit. For example, if the orientation information indicates that the roll is more than 10 degrees away from the longitudinal axis, then the processor may determine the presence of an imbalance in the user's posture.

Equally, the processor may determine that the user's posture is imbalanced if the orientation information indicates that the pitch is more than 5 degrees away from a transverse axis, as shown by line B-B′ in FIG. 2, then the processor may determine the presence of an imbalance in the user's posture. A deviation from the transverse axis could be caused by wrist flexion or extension. Keeping the wrist in flexion or extension for sustained periods can be especially damaging to the wrist joint. Hence, even relatively small deviation from the transverse axis may lead to a determination that the user's posture is imbalanced.

Following a determination to the effect that the user's posture is imbalanced, at step 330 the processor 130 is configured to adjust the weight distribution of the controller 100 to indicate the user to adjust their posture. The indication could be a general indication that the user needs to adjust their posture. The user would understand the indication based on it having been previously explained to them by the video game device, or from prior experience.

Accordingly, the present disclosure provides controller configured to subtly yet intuitively provide the user with an indication to correct imbalances in their posture when they occur during use of a video game system. The user's immersion in the video game is not disrupted, nor or are they subjected to wearing an invasive corrective brace. Moreover, the user is not forcefully made to correct their posture by directly exerting a corrective force on their body. That is, the disclosure provides an approach that encourages the user to adopt an improved posture without taking away their bodily autonomy. By creating a sense of encouragement and cooperation, the user is also more likely to want to correct their posture. On the other hand, if a force was directly applied to the user to make them correct their posture, this may irritate the user and detract from their experience.

Further, by providing the user with the indication to correct their posture, the user will gradually remember to keep a good posture because their posture has been brought to front of mind. The present disclosure therefore also provides for retraining of a user's posture over time, by continued use of the controller.

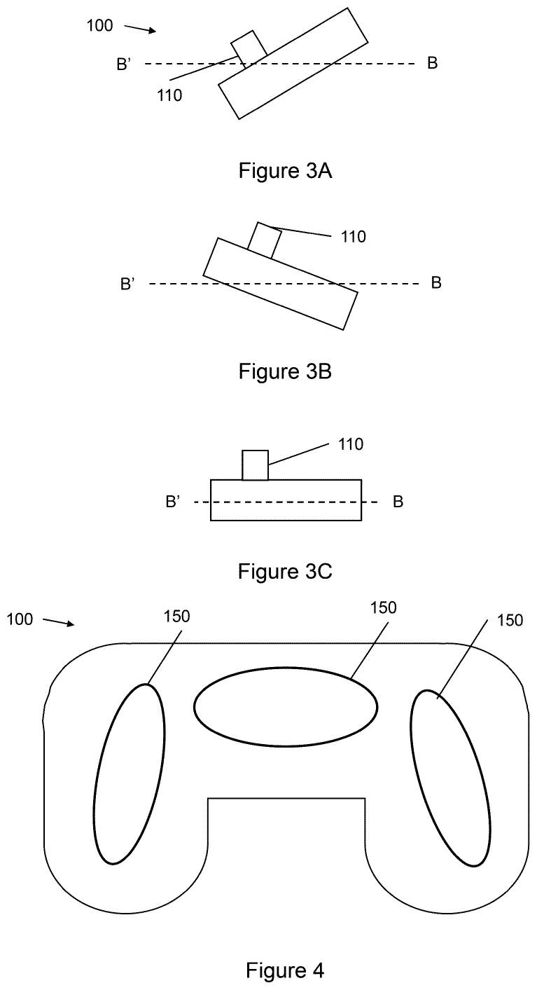

FIGS. 2A, 2B, and 3A to 3C provide visualisations of how the controller 100 may be oriented before and after the user is provided with an indication.

In particular, FIG. 2A shows that the controller 100 is tilted or deviated away from the longitudinal axis. Accordingly, the processor 130 is configured to adjust the weight distribution of the controller 100 to indicate the user to adjust their posture. After the indication is provided, the user naturally returns the controller to a neutral position, as shown in FIG. 2B. That is, after the user adjusts their posture, the controller 100 is realigned with the longitudinal axis.

FIGS. 3A and 3B show how the controller may be tilted or deviated away from the transverse axis. Accordingly, the processor 130 is configured to adjust the weight distribution of the controller 100 to indicate the user to adjust their posture. After the indication is provided, the user naturally returns the controller to a neutral position, as shown in FIG. 3C. That is, after the user adjusts their posture, the controller 100 is realigned with the transverse axis.

However, further advantages can be realised by indicating a posture adjustment to the user. By indicating a posture adjustment, we intended to mean that the weight adjustment of the controller 100 provides the user with an indication that they would understand to correspond to a specific posture adjustment. The user is thus provided with an intuitive indication as to how to correct the imbalance in their posture.

For example, if the user is holding the controller with the left hand being higher than the right hand, as shown in FIG. 2A, this indicates that the user's shoulders or elbows are out of alignment. As such, the processor 130 adjusts the weight distribution of the controller 100 to make the left side of the controller, that is, the part being held by the left hand, heavier. Accordingly, the user would notice that the left of the controller 100 feels heavier, and lower that part of the controller, as shown in FIG. 2B. This would naturally bring their shoulders and elbows back into alignment. That is, the imbalance in their posture is corrected.

In another example, if the user is holding the controller as shown in FIG. 3A, then the processor 130 would adjust the weight of the controller 100 to make the top of the controller heavier, thereby encouraging the user to return the controller 100 to the transverse axis as shown in FIG. 3C.

The controller 100 may also be configured to provide dynamic readjustment of the weight distribution responsive to a change in the user's posture. This involves receiving second orientation information from the gyroscope 140 and determining a difference between the first orientation information and the second orientation information to determine a change in the user's posture. For example, the user may have completely corrected the posture, in which case the weight distribution of the controller is returned to its initial state. On the other hand, if the user has not completely corrected their posture, or the difference in the first orientation information and the second orientation information indicates that another imbalance in the user's posture has arisen, then the weight distribution of the controller 100 may accordingly be adjusted. Accordingly, the method can be dynamic, and provide the user with a useful stream of feedback to give them a better chance at achieved a balanced posture.

We refer now to FIG. 4, which shows the controller 100, together with a plurality of weight shifting means 140. Note that the number and arrangement of weight shifting means is not limited, and another arrangement, with more or fewer weight shifting means could be used. The controller could be provided with one or more weight shifting means.

The weight shifting module 140 facilitate the adjustment of the weight distribution discussed above. There are multiple forms that the weight shifting module 150 could take.

For example, the weight shifting module 150 may comprise a moveable weight connected to or provided within the controller 100. The moveable weight may be slidable, rotatable, or both slidable and rotatable. By moving the moveable weight, the center of mass of the controller 100 shifts, which is sensed by the user. This accordingly indicates to the user that they need to adjust their posture, and may even indicate how to adjust their posture, in accordance with the examples discussed above.

In some examples, the weight shifting module 150 may additionally or alternatively comprise a spinnable motor. Use of a spinnable motor may cause the user to perceive that the weight distribution of the controller 100 has been adjusted, without changing the center of mass of the controller. This is because a spinnable element in the spinnable motor generates lift when it spins. The lift exerts a force on the controller, causing the user to perceive that the weight distribution of the controller 100 has changed. This can lead to a more compact device, since fewer moving parts are required in the controller 100. Equally, if a spinnable motor is used in combination with a moveable weight, then become possible to provide especially strong indications to the user, for example when the user's posture appears to be significantly imbalanced.

It is to be understood that the moveable weight and spinnable motor discussed above are just two ways of implementing a physical or perceived shift in weight distribution. Other ways are of course possible.

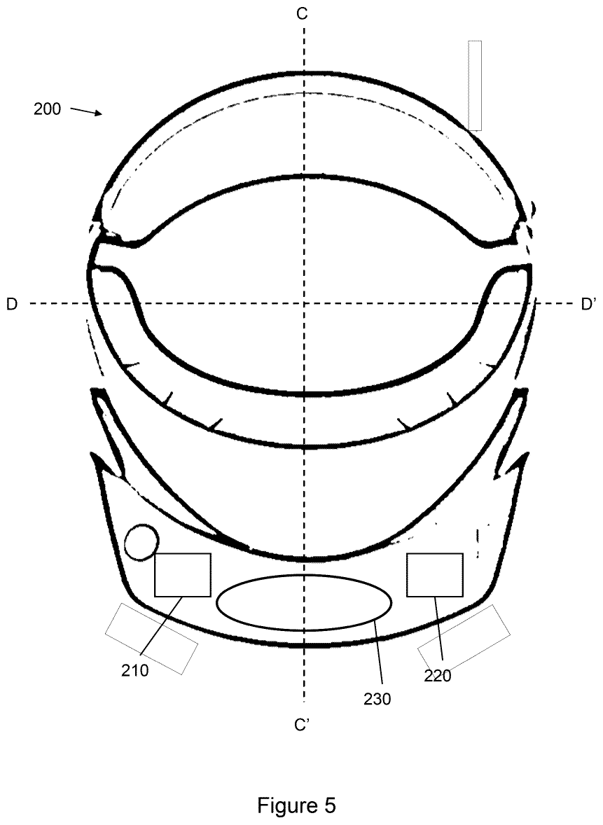

Looking now to FIG. 5, a virtual reality headset 200 is shown. It is to be understood that the examples described above in relation to controller 100 apply to the virtual reality headset 200. To this end, virtual reality headset 200 is provided with a processor 210, an orientation sensor 220, and one or more weight shifting modules 230. A longitudinal axis C-C′ and transverse axis D-D′ are also shown in FIG. 5.

It is especially advantageous to configure virtual reality headset 200 to provide the user with an indication to correct their posture, since while using a virtual reality headset, a user can easily lose track of their posture due to the level of immersion provided by the virtual reality headset. It therefore even more important not to break this immersion. This is achieved by configuring the processor 210 of the virtual reality headset 200 to adjust the weight distribution of the virtual reality headset 200 on determining an imbalance in the user's posture based orientation information of the virtual reality headset 200.

In summary, peripheral devices disclosed herein are configured to provide the user with subtle and intuitive feedback to adjust the posture though adjustments in the weight distribution of the peripheral. This allows the user to use the peripheral comfortably for sustained periods of time. Moreover the indications provided to the user are felt, rather than seen, so the user's immersion in a game and concentration are not broken to the extent they would be by a message flashing up on a screen.

1. A peripheral device of a video game device, configured in use to correct a user's posture, the peripheral device comprising a processor configured to:
obtain first orientation information from an orientation sensor of the peripheral device;
determine an imbalance in the user's posture based on the first orientation information; and
adjust the weight distribution of the peripheral device to provide an indication to the user to adjust their posture.

2. The peripheral device according to claim 1, wherein adjusting the weight distribution of the peripheral device to provide an indication to the user to adjust their posture comprises:
indicating a posture adjustment to the user,
wherein the posture adjustment corrects the imbalance in the user's posture.

3. The peripheral device according to claim 1, wherein the processor is further configured to detect an imbalance based on the first orientation information by:
determining that the first orientation information indicates that the peripheral device is rotated about an axis of the peripheral device.

4. The peripheral device according to claim 3, wherein the axis of the peripheral device comprises a longitudinal axis of the peripheral device.

5. The peripheral device according to claim 3, wherein the axis of the peripheral device comprises a transverse axis of the peripheral device.

6. The peripheral device according to claim 1, wherein the processor is further configured to:
receive second orientation information from the gyroscope of the peripheral device;
determine a difference between the first orientation information and the second orientation information;
determine a change in the user's posture based on the difference between the first orientation information and the second orientation information; and
readjust the weight distribution of the peripheral device responsive to the change in the user's posture.

7. The peripheral device according to claim 1, wherein the peripheral device comprises a moveable weight connected to the peripheral device,
and adjusting the weight distribution of the peripheral device to indicate the user to adjust their posture comprises:
adjusting a position of the moveable weight to shift a center of mass of the peripheral device.

8. The peripheral device according to claim 7, wherein the processor is further configured to detect an imbalance based on the first orientation information by determining that the first orientation information indicates that the peripheral device is rotated about an axis of the peripheral device; and
wherein the center of mass of the peripheral device is shifted to indicate the user to reorient the device by tilting the peripheral device toward the axis of the peripheral device.

9. The peripheral device according to claim 1, wherein the processor is further configured to adjust the user's perception of the weight distribution of the peripheral device.

10. The peripheral device according to claim 9, further comprising a spinnable motor connected to the peripheral device, wherein
the processor is configured to adjust the user's perception of the weight distribution by spinning the spinnable motor.

11. The peripheral device according to claim 1 wherein the peripheral device comprises a video game controller.

12. The peripheral device according to claim 1 wherein the peripheral device comprises a virtual reality headset.

13. The peripheral device according to claim 1, wherein the orientation sensor comprises a gyroscope.

14. A video game system comprising a peripheral device according to claim 1 and a video game device.

15. The system according to claim 14, wherein adjusting the weight distribution of the peripheral device to provide an indication to the user to adjust their posture comprises:
indicating a posture adjustment to the user,
wherein the posture adjustment corrects the imbalance in the user's posture.

16. The system according to claim 14, wherein the processor is further configured to detect an imbalance based on the first orientation information by:
determining that the first orientation information indicates that the peripheral device is rotated about an axis of the peripheral device.

17. The system according to claim 16, wherein the axis of the peripheral device comprises a longitudinal axis of the peripheral device.

18. The system according to claim 16, wherein the axis of the peripheral device comprises a transverse axis of the peripheral device.

19. A method for correcting a user's posture comprising:
obtaining first orientation information from an orientation sensor of a peripheral device;
determining an imbalance in the user's posture based on the first orientation information; and
adjusting the weight distribution of the peripheral device to indicate the user to adjust their posture.

20. A computer readable storage medium comprising instructions, which when executed by a processor of a peripheral device of a video game device, cause the processor to perform a method according to claim 15.
